(19) United States
(12) Patent Application Publication
(10) Pub. No.: US 2024/0265263 A1
(43) Pub. Date: Aug. 8, 2024

(54) METHODS AND SYSTEMS FOR CONSTRAINED REINFORCEMENT LEARNING

(71) Applicant: DeepMind Technologies Limited, London (GB)

(72) Inventors: Theodore Harris Moskovitz, London (GB); Brendan Timothy O'Donoghue, London (GB); Tom Ben Zion Zahavy, London (GB); Johan Sebastian Flennerhag, London (GB); Vivek Veeriah Jeya Veeraiah, London (GB); Satinder Singh Baveja, Ann Arbor, MI (US)

(21) Appl. No.: 18/424,437

(22) Filed: Jan. 26, 2024

Related U.S. Application Data
(60) Provisional application No. 63/441,398, filed on Jan. 26, 2023.

(51) Int. Cl. G06N 3/091

(52) U.S. Cl. CPC G06N 3/091

(57) ABSTRACT

A method is described for iteratively training a policy model, such as a neural network, of a computer-implemented action selection system to control an agent interacting with an environment to perform a task subject to one or more constraints. The task has a reward associated with performance of the task. Each constraint limits to a corresponding threshold the expected value of the total of a corresponding constraint function which if the future actions of the agent are chosen according to the policy model, and each constraint is associated with a corresponding multiplier variable. In each iteration, a mixed reward function is generated based on values for the multiplier variables generated in the preceding iteration, and estimates of the rewards and the values of constraint reward functions if the actions are chosen based on the policy model generated in the preceding iteration.

### CROSS-REFERENCE TO RELATED APPLICATION

This application claims priority under 35 U.S.C. 119 to Provisional Application No. 63/441,398, filed Jan. 26, 2023, which is incorporated by reference.

### BACKGROUND

This specification relates to machine learning, in particular to reinforcement learning.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

In a reinforcement learning system an agent, a robot, interacts with an environment, e.g., a real-world environment, by performing actions that are selected by the reinforcement learning system in response to receiving successive “observations”, i.e. datasets that characterize the state of at least part of the environment at corresponding time-steps, e.g., the outputs of sensor(s) which sense at least part of the real world environment at those time-steps.

### SUMMARY

This specification describes a system, implemented as computer programs on one or more computers in one or more locations, for controlling an agent that is interacting with an environment.

In one aspect there is described a method, and a corresponding system, implemented by one or more computers, for iteratively training a policy model, such as a neural network, of a computer-implemented action selection system within the reinforcement learning system to control an agent interacting with an environment to perform at least one task subject to one or more constraints. Each task has at least one respective reward associated with performance of the task.

The method comprises, in each of a plurality of iterations, modifying the policy model to increase expected future rewards if future actions of the agent are chosen according to the policy model, subject to one or more constraints. Each constraint may be defined based on a corresponding “constraint reward function” which is dependent on the observations and/or on the actions. Each constraint may limit, to a corresponding threshold, the expected value of the corresponding constraint reward function if the actions of the agent are chosen according to the policy model. Each constraint is associated with a corresponding multiplier variable.

Each iteration comprises generating a mixed reward function based on values for the multiplier variables generated in the preceding iteration, and estimates of the rewards and the values of constraint reward functions if the actions are chosen based on the policy model generated in the preceding iteration. The policy model is then updated based on the mixed reward function generated in the current iteration (i.e. the mixed reward function based on the policy model generated in the preceding iteration) and the mixed reward function generated in the preceding iteration (i.e. the mixed reward function based on the policy model generated in the last-but-one iteration). Specifically, it can be updated to be a new policy model which maximizes a function of an expected value of the mixed reward function generated in the current iteration under the new policy model, and of an expected value of the mixed reward function generated in the preceding iteration under the new policy model. Each multiplier variable is similarly updated based on an expected value for the constraint reward function if actions are chosen using the policy model generated in the previous iteration, on an expected value for the constraint reward function if actions are chosen using the policy model generated in the preceding iteration (i.e. the last-but-one iteration), and on the corresponding threshold.

It is found experimentally, and can be demonstrated mathematically, that, in implementations, training of the policy model in this way leads to “last iterate” convergence (LIC). That is, after a large number of iterations the policy model reaches a form which generates actions which both satisfy the constraints (subject to a tolerance) and which perform the task(s) (e.g. achieve high reward values for the task(s)).

This is in contrast to some other policy model training methods which only achieve convergence in an average sense over multiple policy models (“average iterate convergence”, AIC), such as multiple policy models generated in respective successive iterations of the policy model training method, or multiple policy models generated iteratively from different initial configurations. That is, a given policy model produced after many training iterations generates actions which are either successful at solving the task or at meeting the constraints, such that on average actions produced by multiple such policy models do both, but a given policy model produced after many training iterations may not generate actions which satisfy both the objectives. As an illustration, consider a case in which an agent is a humanoid mechanical robot, and the task is training the agent to walk subject to a constraint which is an upper limit on the robot's height. Examples of the present disclosure control the agent to do this. By contrast, some training methods generate successive policy models over a single training run which either cause the agent to walk normally, or cause the agent to lie on the ground.

### BRIEF DESCRIPTION OF THE DRAWINGS

Examples of the present disclosure are explained with reference to the following drawings.

FIG. 1 shows an example action selection system within a reinforcement learning system.

FIG. 2 explains an “optimistic” learning process for training a policy model.

FIG. 3 is composed of FIG. 3(a) which defines as Constrained Markov Decision Process, and FIG. 3(b) which shows experimental results from a training method which is an example of the present disclosure, and another training method.

FIGS. 4 and 5 show experimental results from a training method which is an example of the present disclosure, and another training method, for two different constrained tasks of controlling the motion of a robot subject to a constraint.

FIG. 6 shows steps of an example method disclosed here.

FIG. 7 shows a robot including a control system.

### DETAILED DESCRIPTION

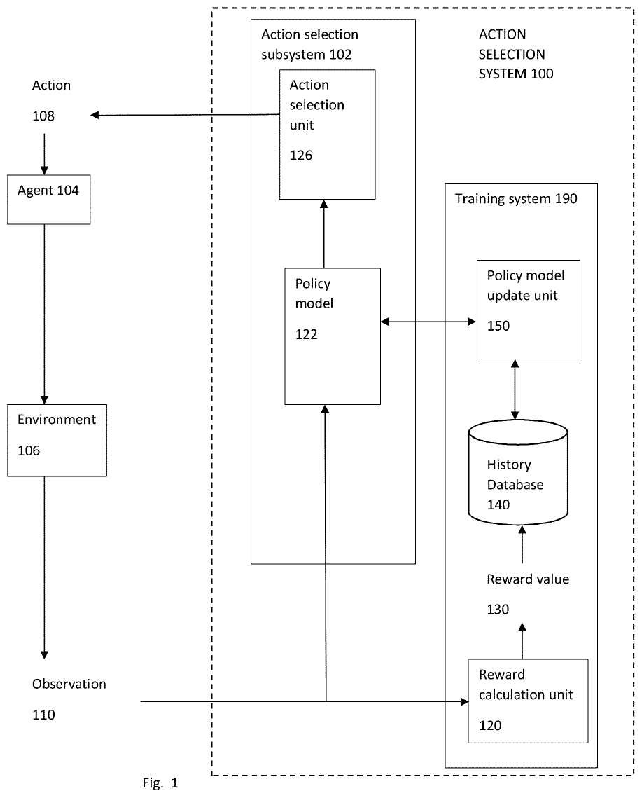

FIG. 1 shows a reinforcement learning system including an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple corresponding time steps during an episode in which the task is performed.

As a general example, the task can include one or more of, e.g., navigating to a specified location in the environment, identifying a specific object in the environment, manipulating the specific object in a specified way, controlling items of equipment to satisfy criteria, distributing resources across devices, and so on. More generally, the task is specified by received rewards, e.g., such that an episodic return is maximized when the task is successfully completed. Rewards and returns will be described in more detail below. Examples of agents, tasks, and environments are also provided below. For simplicity, this description assumes that only one task is performed, but more generally there may be multiple tasks (which may also be considered components of a single task) associated with multiple corresponding rewards.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. An action to be performed by the agent will also be referred to in this specification as a “control input” generated by the action selection system 100. After the agent performs the action 108, the environment 106 transitions into a new state at the next time step.

To control the agent, at each time step in the episode, an action selection subsystem 102 of the system 100 may use a policy model 122 (which, as explained below may optionally be implemented as a policy model neural network) and optionally an action selection unit 126 (e.g. a low-level controller neural network performing a fixed function) to select the action 108 that will be performed by the agent 104 at the time step based on the output of the policy model 122 (the “policy output”). The action selection subsystem 102 uses the policy model 122 to process the observation 110 to generate the policy output, and then the action selection unit 126 uses the policy output to select the action 108 to be performed by the agent 104 at the time step.

The function performed by the policy model 122 is denoted by π. In the case that the policy model 122 is a policy model neural network, it is defined by a set of parameters ϕ which may comprise weights and/or bias values of neural units (nodes), each of which is located in one of one or more layers of the policy model neural network, and which generates an output as a function (e.g. a non-linear function) of a weighted sum of the inputs to the neural unit plus a bias value. The input to the policy model 122 comprises the observation 110.

In one example, the policy output may uniquely identify an action (e.g. it may be a “one-hot” vector which has respective components for each possible action, and for which only one of the components is non-zero, indicating that the corresponding action should be taken). In this case, the action selection unit 126 may be omitted (i.e. the policy output may be transmitted, as control data specifying the action 108, to the agent 104), or the action selection unit 126 may merely translate the policy output into a control input (i.e. control data in a format the agent can recognize and implement) to cause the agent 104 to perform the identified action 108.

In another example, the policy output generated by the policy model 112 upon receiving observation 110 may include a respective numerical value for each action in a set of actions. For example, the policy output may include a respective Q-value for each action in the fixed set. A Q-value for an action is an estimate of a return that would result from the agent performing the action in response to the current observation and thereafter selecting future actions performed by the agent in accordance with current values of the parameters of the policy model neural network 122 and the action selection unit 126.

In one case, the policy model 122 may generate numerical values (e.g. Q-values) upon receiving the observation 100, i.e. numerical values for each of a set of possible actions. Alternatively, the action selection system may successively provide inputs to the policy neural network 122 which are each a combination of the observation 110 and one of the set of possible actions, and the policy output may be formed from the corresponding successive outputs (e.g. Q-values) of the policy neural network 122.

The action selection unit 126 may select the action 108 based on the numerical values, e.g., by selecting the action with the highest numerical value, or by treating the numerical values in the policy output as a defining a probability distribution over the set of actions, and sampling an action in accordance with the probability distribution. For example, if the numerical values are Q-values, the action selection unit 126 may process the Q-values (e.g., using a soft-max function) to generate a respective probability value for each action, which may be used to select the action, or may select the action with the highest Q-value.

As another example, when the action space is continuous, the policy output may include parameters of a probability distribution over the continuous action space and the action selection unit 126 can select the action by sampling from the probability distribution or by selecting the mean action. A continuous action space is one that contains an uncountable number of actions, i.e., where each action is represented as a vector having one or more dimensions and, for each dimension, the action vector can take any value that is within the range for the dimension and the only constraint is the precision of the numerical format used by the system 100.

As yet another example, when the action space is continuous the policy output may include a regressed action, i.e., a regressed vector representing an action from the continuous space, and the action selection unit 126 may select the regressed action as the action 108.

Each observation 110 describes (“characterizes”) the state of the environment 106. In some cases, an observation 110 completely describes the state of the environment at that time, but more generally the observation may not fully describe the state (e.g. it may only show part of the environment, or only show a view of the environment from one perspective).

The action 108 performed by the agent 104 at time t is denoted aₜ selected from a space of possible actions denoted [symbol] . At each time step t (except an initial time step, which may be denoted t=0), the state of the environment 106 at the time step, as characterized by the observation 110, is denoted sₜ selected from a space of actions denoted [symbol] . The state sₜ depends on the state sₜ₋₁ of the environment 106 at the previous time step t−1 and the action 108 performed by the agent 104 at the previous time step (i.e. aₜ₋₁). A transition kernel for the environment may be denoted by: [symbol] : [symbol] × [symbol] → [symbol] (S), indicating a probability distribution over the space S. The distribution of the initial states of the environment 106 is denoted ρ∈ [symbol] (S).

The policy model 122 can be trained by a training system 190. For example, example if the policy model 122 is a policy model neural network defined by a set of numerical parameters (e.g. millions or even billions of parameters), the training system 190 can iteratively vary those parameters. This training may be performed in parallel with the selection of actions 108 by the action selection subsystem 102 (“online” training). Alternatively, it can be performed based one accumulated trajectories (e.g. stored in a history database 140) without adding to those trajectories during the training (“offline learning”). Once the policy model neural network 122 has been trained, the training system 190 may be removed from the action selection system 100, e.g. discarded.

Generally, the training is based on a reward value 130 for each observation which is dependent on (i.e. derived using) the observation 110, and which is generated using the observation 110 by a reward calculation unit 120. The reward value (or more simply “reward”) for a given time t, is a scalar numerical value and characterizes the progress of the agent 104 towards completing the task. A tuples each including a realization of sₜ, aₜ, sₜ₊₁ and the resulting reward value 130 may be stored in the history database 140.

The reward value 130 is the numerical value of a reward function r₀, where r₀: [symbol] × [symbol] → [symbol] . The reward function may include multiple terms which are summed to produce the reward value 130. The reward function may comprise a sparse binary reward term that is zero unless the task is successfully completed as a result of the last action performed, i.e., is only non-zero, e.g., equal to one, if the task is successfully completed as a result of the last action performed. As another example, the reward function can comprise a dense reward term that measures a progress of the agent towards completing the task as of individual observations received during the episode of attempting to perform the task, i.e., so that non-zero rewards can be and frequently are received before the task is successfully completed.

A policy model update unit 150 of the training system 190 trains (i.e. iteratively modifies) the policy model 122 based on the reward values 130, e.g. such that, while performing any given task episode, the system 100 selects actions which tend to increase the rewards 130. The training process is called “reinforcement learning”. In many reinforcement learning methods, the policy model update unit 150 iteratively modifies the policy model 122 in order to attempt to maximize a return that is received over the course of the task episode. That is, the policy model 122 may be trained such that, at each time step during the episode, the action selection subsystem 102 selects actions that attempt to maximize the return that will be received for the remainder of the task episode starting from the time step. More generally, the policy model update unit 150 modifies the policy model neural network 122 such that the action selection subsystem 102, upon receiving an observation 110, selects an action 108 which is statistically associated with a high future return which is a (weighted) sum of the values of r₀ over multiple future time steps (i.e. the corresponding rewards for multiple future observations).

Generally, at any given time step, the return that will be received is a combination of the reward values 130 that will be received at time steps that are after the given time step in the episode. For example, at a time step t, the return can satisfy:

$${\sum }_{i} {γ}^{i - t - 1} {r}_{0 , i} , \qquad ( 1 )$$

where i ranges either over all of the time steps after t in the episode or for some fixed number of time steps after t within the episode, γ∈[0, 1) is a discount factor that is greater than zero and less than or equal to one, and r_{0,i} is the reward value 130 at time step i.

The policy model update unit 150 is further required to train the policy model 122 to control the agent to perform the task(s) subject to one or more constraints on the actions. Examples of constraints include energy expended whilst performing the task, and physical constraints on motion of the agent such as on the force exerted by an actuator within the agent during the task, or on a measure of physical wear-and-tear during the task, or on configurations of the agent (e.g. that the agent should not adopt a configuration such that its total height is above a threshold). For example, a constraint may be chosen to ensure operation of the agent.

Each constraint may be defined based on a corresponding “constraint reward function”, dependent on that observations 110 and/or on the actions 108 selected by the action selection system 100. Each constraint may limit, to a corresponding threshold, the expected value of the total of the corresponding constraint functions which the system receives if the future actions of the agent are chosen according to the policy model. The number of constraints may be denoted N, and they are indexed by the integer variable n=1, . . . , N. Each constraint reward function is denoted rₙ, e.g. rₙ(s, a). It limits the corresponding total expected value vₙ^{π} of a corresponding constraint reward function (e.g. the total over the whole trajectory) if actions are selected by policy model 122, denoted π, to be subject to a corresponding maximum value θₙ. The set of values {θₙ} can also be written as the vector θ. This defines a limit to the expected value for all the corresponding constraint reward functions rₙ. The overall reinforcement learning system is a Constrained Markov Decision Process (CMDP) defined by a tuple [symbol] _{c}=( [symbol] , [symbol] , r₀, γ, ρ, {rₙ}ₙ₌₁^{N}, {θₙ}ₙ₌₁^{N}).

The process of the action selection subsystem 102 selecting an action 108 at each time step by sampling from a stationary policy π (selected from a space of possible policies denoted Π) can be written as π: [symbol] → [symbol] (A). For the sake of example, treating the episode as being potentially infinitely long gives a cumulative, discounted state-action occupancy measure (or simply “occupancy measure”) associated with the policy of

$${d}_{π} ( s , a ) ≡ ( 1 - γ ) {\sum }_{t = 0}^{∞} {γ}^{t} π ( a \vert s ) {P}_{π} ( {s}_{t} = s ) . \qquad ( 2 )$$

This lies within a convex feasible set (a polytope in the case that the spaces [symbol] and [symbol] are discrete). The goal of the training system 190 is to train the policy model 122 to be the policy π in a space denoted [symbol] which maximizes the expected, cumulative, discounted reward while adhering to the designated constraints. This quantity is referred to as the policy's value v₀^{π}≡ [symbol] r₀, d_{π}(s, a) [symbol] , and the goal may be formalized as finding

$$\begin{matrix}min \\ π\end{matrix} - {v}_{0}^{π}$$

such that vₙ^{π}≤θₙ, where vₙ^{π} denotes the expected value of the n-th constraint reward function rₙ given d_{π}, that is vₙ^{π}≡ [symbol] rₙ, d_{π}(s, a) [symbol] . Typically, CMDPs are solved by Lagrangian relaxation, defining a Lagrangian as:

$$ℒ ( {d}_{π} , µ ) ≡ - 〈 {r}_{0} , {d}_{π} 〉 + {\sum }_{n = 1}^{N} {µ}_{n} ( 〈 {r}_{n} , {d}_{π} 〉 - {θ}_{n} ) , \qquad ( 3 )$$

where μ denotes a set {μₙ}ₙ₌₁^{N} of N multiplier variables associated with respective ones of the constraints, and finding

$$\begin{matrix}min & max \\ {d}_{π} ∈ 𝒦 & µ \geq 0\end{matrix} ℒ ( {d}_{π} , µ ) = \begin{matrix}min & max \\ {d}_{π} ∈ 𝒦 & µ \geq 0\end{matrix} [ - 〈 {r}_{0} , {d}_{π} 〉 + {\sum }_{n = 1}^{N} {µ}_{n} ( 〈 {r}_{n} , {d}_{π} 〉 - {θ}_{n} ) ] . \qquad ( 4 )$$

In other words, a saddle-point in the Lagrangian function is identified.

In view of Eqn. (4), the policy model update unit 150 of the action selection system 100 may perform an iterative training process in which each update is based on a “mixed reward vector” r_{μ} which is defined by r_{μ}=−r₀+Σₙ₌₁^{N}μₖrₙ. The motivation for this is that the mixed reward vector is ∇_{d}_{_{π}} [symbol] . Desirably, the training process would lead to convergence towards the saddle point defined by Eqn. (4).

Most conventional procedures for finding a saddle point of a smooth function (that is, to minimize a smooth function with respect to one or more first variables, and maximize it with respect to one or more second variable(s)) are only guaranteed to converge in an average sense (average iterate convergence, AIC). In other words, the values of the first and second variables at the saddle point is the average over many iterations of the corresponding variables generated at each iteration. In more detail, the algorithm tends to display a cyclic behavior in which successive iterations are distributed around the saddle point.

Finding the saddle point as an average of the outputs at many iterations is unhelpful in the present situation, because, even if the state-action distribution d_{π} at the saddle point could be determined, it may not be straightforward to design a policy model 122 which produces this state-action distribution. This is particularly the case when the policy model is a neural network which has a complex relationship between the parameters of the neural network and the state-action distribution it produces. For example, even if a setting ϕ^{k} for the parameters of the policy model 122 is known which produces a state-action distribution d_{π}^{k} produced in the k-th iteration, averaging the parameters ϕ^{k} over many values of k would result in a set of parameters which defines a policy model 122 which would produce a state-action distribution which is different from the average of d_{π}^{k} over multiple values of k.

The best known methods for determining a saddle point rely in each iteration on finding a gradient of the Lagrangian function with respect to the first and second variables at the values of the first and second variables found in the previous iteration. By contrast, a recent optimization technique (“Optimistic mirror descent”—see for example Daskalakis, C. and Panageas, I. “The limit points of (optimistic) gradient descent in min-max optimization”, 2018a, https://arxiv.org/abs/1807.0397, the disclosure of where is incorporated by reference) employ gradients of the Lagrangian function at values for the first and second variables derived in more than one previous iteration, such as the previous iteration and the iteration immediately before that. A similar “optimistic” approach is adopted here.

In particular, in an example of the present disclosure known as ReLOAD (Reinforcement Learning with Optimistic Ascent-Descent) the policy model update unit 150 uses an iterative training method in which, in the k-th iteration (where k is an integer index in the range 1, . . . , K denoting an iteration in K steps), comprises two steps of the following form:

$${d}_{π}^{k + 1} = \begin{matrix}argmin \\ {d}_{π} ∈ 𝒦\end{matrix} [ 〈 {\tilde{r}}_{µ}^{k} , {d}_{π} 〉 + \frac{1}{{η}_{π}^{k}} {D}_{{Ω}_{π}} ( {d}_{π} ; {d}_{π}^{k} ) ] \qquad ( 5 )$$

$${µ}^{k + 1} = \begin{matrix}argmin \\ µ \geq 0\end{matrix} [ 〈 {\tilde{v}}_{1 : N}^{k} - θ , µ 〉 - \frac{1}{{η}_{π}^{k}} {D}_{{Ω}_{π}} ( µ ; {µ}^{k} ) ] \qquad ( 6 )$$

where \tilde{r}_{μ}^{k}≡2r_{μ}^{k}−r_{μ}^{k-1} and \tilde{v}_{1:N}^{k}≡2v_{1:N}^{k}−v_{1:N}^{k-1}. Here D_{Ω}_{_{π}}(d_{π}; d_{π}^{k}) is a measure of the divergence of d_{π} and d_{π}^{k}, and is referred to as a “policy stabilization function”. D_{Ω}_{_{μ}}(μ; μ^{k}) is a measure of the divergence of μ and μ^{k}, and is referred to as a “multiplier stabilization function”. η_{π}^{k} and η_{μ}^{k} (which may be the same, i.e. chosen to be a single value denoted η^{k}) are referred to respectively as the first and second step size parameters. They are hyper-parameters which are a measure of a permitted step-size for the respective update amounts. The values of η_{π}^{k} and η_{μ}^{k} may be chosen in any way, such as to decrease with increasing k. For example, each may be chosen as η^{k}=1−k/K. Alternatively, in some variations η_{π}^{k} and η_{μ}^{k} are the same for all k, in which case they are denoted simply as η_{π} and η_{μ}, or if they are the same simply as η.

v_{1:N}^{k} is a vector having one component for each constraint. Its n-th component vₙ^{k} denotes the expected value of the n-th cost function rₙ given the state-action distribution d_{π}^{k}. The notation μ≥0 means that each component μₙ of μ is greater than or equal to zero.

Note that updates to d_{π} are based on the mixed reward vector r_{μ}^{k} generated in the current iteration, and the mixed reward vector r_{μ}^{k-1} generated in the preceding iteration. This is inspired by the “optimistic” approach to min-max problems mentioned above.

Similarly, updates to each component (multiplier variable) of the vector of multiplier variables μ are based on the expected value vₙ^{k} of the n-th constraint reward function rₙ given the state-action distribution d_{π}^{k} generated in the preceding iteration, and the expected value vₙ^{k-1} of the n-th cost function rₙ given the state-action distribution d_{π}^{k-1} generated in the last-but-one iteration.

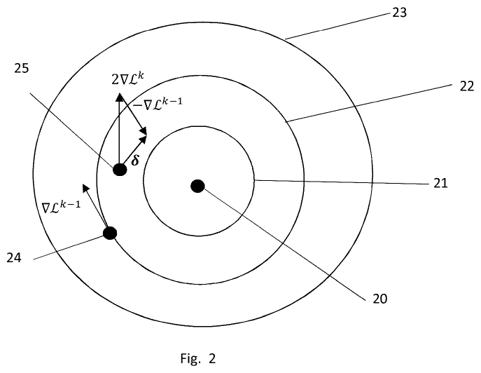

It can be demonstrated that the sequence (d_{π}^{k}, μₖ) generated in this way has last-iterate convergence (LIC). The intuition for this is shown in FIG. 2. This shows schematically the space of the possible realizations of two parameters of (d_{π}, μ). The point 20 is a saddle point where the Lagrangian has zero gradient. Each contour 21, 22, 23 is a set of points where the magnitude of ∇ [symbol] has a respective equal magnitude. The point 24 represents the output value (d_{π}^{k-1}, μ^{k-1}) from the (k−2)-nd iteration, and the arrow extending from point 24 shows the vector ∇ [symbol] ^{k-1}, i.e. the gradient of the Lagrangian for the values (d_{π}^{k-1}, μ^{k-1}) The point 25 represents the output value (d_{π}^{k}, μ^{k}) from the (k−1)-nd iteration, and the arrow extending from point 25 shows 2∇ [symbol] ^{k}, i.e. twice the gradient of the Lagrangian for the values (d_{π}^{k}, μ^{k}). The update to the (d_{π}^{k}, μ^{k}) includes a component which is shown as S and which is 2∇ [symbol] ^{k}−∇ [symbol] ^{k-1}. It will be seen that vector δ is directed more towards the centre point 20 than the vector ∇ [symbol] ^{k}, and thus an update which includes a component in the direction S tends to result in convergence to saddle point 20.

Denoting μ at the saddle point 20 by μ*, the saddle point 20 is a policy π* which is an optimal policy with respect to the μ*-weighted mixed reward r_{μ*}. There might exist other policies that are optimal with respect to r_{μ*} but are not in Nash equilibrium with μ*, but the iterative process defined by Eqns. (5)-(6) is guaranteed to converge in last iterate to π*, and not to these other policies. This is in contrast to a different algorithm which maximizes the stationary reward r_{μ*}. This will be optimal with respect to r_{μ*} but will not necessarily return π*, and will therefore not be in Nash equilibrium with μ*.

The discussion above is in terms of the state action distribution d_{π}^{k}, but in many implementations the policy model update unit 150 performs its task by updating the policy π performed by the policy model 122, rather than d_{π}^{k}. Virtually all scalable reinforcement learning algorithms either learn a policy directly, or define one implicitly, e.g. via q-learning. ReLOAD based on Eqns. (5)-(6) can be performed using such a known reinforcement learning method to give an algorithm for LIC in a constrained problem. The modification of standard reinforcement learning methods of the type which learn a policy directly, to use Eqns. (5)-(6) is straightforward. In some cases, this is performed in an iterative training process for which each iteration is the pair of steps defined by Eqns. (5) and (6). Each iteration includes an inner loop to implement Eqn. (5) performed using the standard reinforcement learning methods to find a policy which maximises \tilde{r}_{μ}^{k} (instead of r₀ as in the standard reinforcement learning methods) for a given set of values μ.

The case of incorporating the method of Eqns. (5)-(6) into learning techniques will now be considered. The (expected) value of the policy π, i.e. [symbol] r₀, d_{π} [symbol] , can be re-written [symbol] q_{π}, π [symbol] . Here the return function q_{π}(s, a)≡ [symbol] _{π}[Σ_{t≥0}γ^{t} r_{0,t}|s₀=s, a₀=a], which is not convex in π.

For a given constraint, the expected future value of the n-th constraint reward function given the policy π and the initial state (a, s) is denoted by q_{π,r}_{ₙ} or more simply qₙ. It is a function of arguments (a, s). It may be such that the expected future value of the constraint reward function rₙ (e.g. the value of the constraint reward function if the next action is a and future actions are selected according to the policy model π) is equal to vₙ^{π}.

The Lagrangian of Eqn. (3) is re-written as:

$$ℒ ( {d}_{π} , µ ) = - 〈 {r}_{0} , {d}_{π} 〉 + {\sum }_{n = 1}^{N} {µ}_{n} ( 〈 {r}_{n} , {d}_{π} 〉 - {θ}_{n} ) = 〈 - {q}_{0} + {\sum }_{n = 1}^{N} {µ}_{n} {q}_{n} , π 〉 - 〈 µ , θ 〉 = ℒ ( π , µ )$$

Note that in the non-parametric setting (e.g. a tubular situation described below), ∇_{π} [symbol] =−q₀+Σₙ₌₁^{N}μₙqₙ. In other words, gradient estimation is equivalent to policy evaluation, resulting in the mixed q-value

$${q}_{µ} = - {q}_{0} + {\sum }_{n = 1}^{N} {µ}_{n} {q}_{n} .$$

The gradient of the Lagrangian with respect to the multiplier values is ∇_{μ} [symbol] =v_{1:N}−θ, as in the case explained above.

The implementation of the family of algorithms given by Eqns. (5)-(6), and variations thereto, will now be described for several examples in terms of iterative updates to the policy if or the q-values, and the multiplier values μ. As noted, these are based on updates given by 2∇ [symbol] ^{k}−∇ [symbol] ^{k-1} and with a step-size limited using the divergences D_{Ω}_{_{π}} and D_{Ω}_{_{μ}}, with the effect of these divergences being controlled by the hyper-parameters η_{π} and η_{μ}, which may optionally be the same value denoted η.

In general terms, these algorithms comprise, in each of a plurality of iterations, modifying the policy model π to increase expected future rewards if future actions of the agent are chosen according to the policy model, subject to one or more constraints.

In an initialization step, initial values for π¹, μ¹, π², μ² are chosen, for example, at random, or at the result of another reinforcement learning algorithm.

There are K iterations, labelled k=1, . . . K, where k and K are integers, performed based on Eqns. (5)-(6). In the case of q-learning, for example, implementing Eqn. (5) comprises:
(1) generating a mixed reward function q_{μ}^{k}, based on (i) a return function q₀^{k} indicative of expected future rewards is actions are chosen using the policy model π^{k} generated in the preceding iteration, (ii) for each constraint n, a corresponding constraint cost function qₙ^{k}, indicative of expected values of the corresponding constraint reward function rₙ if the actions of the agent 104 are chosen using the policy model π^{k} generated in the preceding iteration, and (ii) for each constraint n, a value of the corresponding multiplier variable μₙ^{k} generated in the preceding iteration. For example, if π^{k} is a policy neural network, the values of q₀^{k} and {qₙ^{k}}ₙ₌₁^{N} can typically be derived using a conventional policy evaluation module.
(2) generating an updated policy model π^{k+1} based on the mixed reward function q generated in the current iteration and the mixed reward function q_{μ}^{k-1} generated in the preceding iteration, typically to maximize a function which includes the expected value under policy model π^{k+1} of the mixed reward function q_{μ}^{k} generated in the current iteration and the expected value under policy model π^{k+1} of the mixed reward function q_{μ}^{k-1} generated in the preceding iteration. This may be done using a standard q-learning reinforcement learning algorithm. The mixed reward function q_{μ}^{k-1} may have been stored in the preceding iteration, so it is available for in the current iteration.

Eqn. (6) is implemented by generating an updated value μₙ^{k+1} of each multiplier variable (n=1, . . . , N) based on an expected value vₙ^{k} for the corresponding constraint function if actions are chosen using the policy model π^{k} generated in the previous iteration, an expected value vₙ^{k-1} for the cost function if actions are chosen using the policy model π^{k} generated in the preceding iteration, and the corresponding threshold θₙ. This may include finding the value for vₙ^{k} as [symbol] qₙ^{k}, π^{k} [symbol] , and remembering the value of vₙ^{k-1} from the previous iteration.

As described below, the present algorithm may be deployed in both a “tabular” implementation in which the values of the policy and mixed reward functions are explicitly derived for all state-action combinations, and in implementations in which both the policy network and mixed reward function are implemented as adaptive systems such as neural networks.

Although the implementation of Eqn. (5) is based on 2∇ [symbol] ^{k}−∇ [symbol] ^{k-1}, e.g. in the case of q-learning it is based on 2q_{μ}^{k}−q_{μ}^{k-1}, more generally updates to the policy model may be based on values other than 2. For example, in the case of q-learning, the implementation of step (5) may use the values of αq_{μ}^{k}−q_{μ}^{k-1}, where α is a weight factor which may take any real value greater than one, with 2 being just one example. For a range of values for α, updating the policy model based on the mixed reward function from two consecutive iterations reduces the risk of cyclic behavior which alternately generates policy models which perform the task well and policy models which obey the constraints. To put this another way, it makes it more likely that iterative training will converge towards a policy π* which is a saddle-point of the Lagrangian, and which both performs the task well and satisfies the constraints (subject to a tolerance). In a simple case, for example, the policy model π^{k+1} generated in the k-th iteration may be the policy model π^{k+1} which minimizes:

$$- 〈 ( α {q}_{µ}^{k} - {q}_{µ}^{k - 1} ) , {π}^{k + 1} 〉 + \frac{1}{{η}_{π}} {D}_{{Ω}_{π}} ( {π}^{k + 1} , {π}^{k} )$$

where D_{Ω}_{_{π}}(π^{k+1}, π^{k-1}) is the policy stabilization function, which is based on (and is a measure of) a divergence between the policy model π^{k+1} generated in the current iteration and the policy model π^{k} generated in the preceding iteration. For simplicity in the following it will mostly be assumed that the weight factor α=2.

In the expression above, the parameter

$$\frac{1}{{η}_{π}}$$

is a first step size parameter, which may be chosen to take any positive constant value (or different values at different iterations).

Similarly, the updates to the values of the multiplier variables μ^{k} not need be based on 2v^{k}−v^{k-1}−θ as in Eqn. (6), but more generally may be based on βv^{k}−δv^{k-1}−θ. Here v^{k} is an N-component vector having components {vₙ^{k}}, where vₙ^{k} is the expected value for the k-th cost function if actions are chosen using the policy π^{k}. β and δ are respectively first and second constraint weight factors which may take any real value, typically with β greater by one than δ, and may for example be chosen to be respectively 2 and 1. In one case, the policy model μ^{k+1} generated in the k-th iteration may maximize (subject to each component of μ^{k+1} being greater than zero):

$$- 〈 ( β {v}^{k} - δ {v}^{k - 1} - θ ) , {µ}^{k + 1} 〉 - \frac{1}{{η}_{µ}} {D}_{{Ω}_{µ}} ( {µ}^{k + 1} , {µ}^{k} )$$

where D_{Ω}_{_{μ}}(μ^{k+1}, μ^{k}) is the multiplier stabilization function, which is based on (and a measure of) a divergence between the values μ^{k+1} of the multiplier variables generated in the current iteration and the values μ^{k} of the multiplier variables generated in the preceding iteration. In the expression above, the parameter

$$\frac{1}{{η}_{µ}}$$

is a second step size parameter which may be the same as the first step size parameter

$$\frac{1}{{η}_{π}} ;$$

that is, both can be denoted 1/η. In a variation, a different first and/or second step size parameter

$$\frac{1}{{η}_{µ}^{k}} and / or \frac{1}{{η}_{π}^{k}}$$

may be chosen differently for each iteration k. In the following discussion it is mostly assumed for simplicity that β and δ are respectively 2 and 1.

One natural choice for the policy stabilization function, D_{Ω}_{_{π}}(π^{k+1}, π^{k}) is the Kullback-Leibler divergence between the policy model generated in the current iteration and the policy model generated in the preceding iteration.

One natural choice for D_{Ω}_{_{μ}}(μ^{k+1}, μ^{k}) is ½∥μ^{k+1}−μ^{k}∥₂², i.e. proportional the square of the Euclidean difference (Euclidean distance) between μ^{k+1} and μ^{k}. In this case, the update defined by Eqn. (6) takes a simple form:

$${µ}^{k + 1} = \begin{matrix}argmin \\ µ \geq 0\end{matrix} [ 〈 {\tilde{v}}_{1 : N}^{k} - θ , µ 〉 - \frac{1}{{η}_{µ}} {D}_{{Ω}_{µ}} ( µ ; {µ}^{k} ) ] = max \{ {µ}^{k} + {η}_{µ} ( 2 {v}_{1 : N}^{k} - {v}_{1 : N}^{k} - θ ) , 0 \}$$

where the max operation is performed separately for each component, and 0 is an N-component vector of zeros.

In some “tabular” implementations, particularly ones having a small number of possible actions and/or a small number of possible states of the environment, in each k-th iteration the values of q_{μ}^{k}(a, s) and π^{k+1} (a, s) may be calculated for all possible combinations (a, s), as respective tables. Specifically, for example, the values of qₙ^{k}(a, s) and g₀^{k}(a, s) may be obtained for all possible combinations (a, s) from π^{k} (such as by using a “policyeval” function; several such algorithms are known, such as rollout-based estimation, LSTD-Q (Least Squares Temporal Difference), or fitted Q-iteration). From {qₙ^{k}}, the values of vₙ^{k} for n from 1 to N (that is, v_{1:N}^{k}) can be obtained.

In a simple case, such as using in the k-th iteration, the new policy model π^{k+1} may be generated, based on the expected values of the mixed reward functions q_{μ}^{k}−q_{μ}^{k-1} under the new policy model, as:

$${π}^{k + 1} = \begin{matrix}argmin \\ π ∈ Π\end{matrix} - 〈 ( 2 {q}_{µ}^{k} - {q}_{µ}^{k - 1} ) , π 〉 + \frac{1}{η} KL [ π ‖ {π}^{k} ] ,$$

which by can be evaluated as:

$${π}^{k + 1} ∝ {π}^{k} exp ( ( 2 {q}_{µ}^{k} - {q}_{µ}^{k - 1} ) / {η}_{π}^{k} ) .$$

The constant of proportionality may be chosen as the reciprocal of [symbol] π^{k} exp((2q_{μ}^{k}−q_{μ}^{k-1})/η_{π}^{k} [symbol] , where 1 is a vector of is.
The multiplier variables μ^{k+1} can be set in the k-th iteration as the higher of 0 and

$${µ}^{k} + {η}_{µ}^{k} ( 2 {v}_{1 : N}^{k} - {v}_{1 : N}^{k - 1} - θ ) .$$

As discussed above, the values of η_{π}^{k} and η_{μ}^{k} may be chosen in any way, normally so as to decrease with increasing k. For example, they may be chosen to be the same (denoted η^{k}) for each value of k, for example as η^{k}=1−k/K.

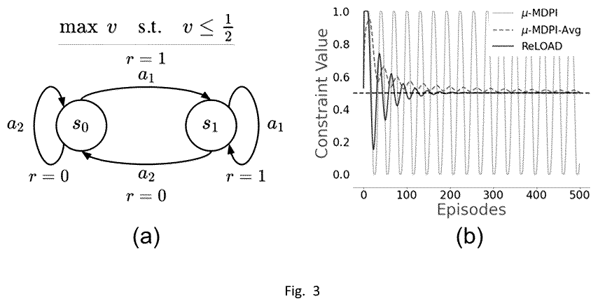

Experimental results are presented in FIG. 3. FIG. 3(a) shows a “toy” example, which is a two-state CMDP. In this task, there are only two states, denoted s₀ and s₁, and only two possible actions a₁ and a₂. The transitions between states based on the actions are shown in FIG. 3(a). The reward r₀ is 1 when the agent takes action a₁ which places the environment in state s₂. The reward r₀ is 0 otherwise. There is a single constraint function r₁ which is equal to the primary reward r₀, and which is associated with the threshold value θ₁=½. Due to this constraint, the agent 104 should choose action a₁ only half the time.

FIG. 3B plots the constraint value over the course of the learning using two algorithms. “ReLOAD” is an example of the present disclosure. “μ-MDPI” is a variant of the algorithm MDPI (Markov Decision Policy Iteration) proposed by Geist, M., et al., “A theory of regularized Markov decision processes”, in Proceedings of the 36^{th} International Conference on Machine Learning, 2019, URL https://proceedings.mlr.press/v97/geist19a.html. In the variant “μ-MDPI”, the updating of the policy is performed using the mixed q-value q_{μ}^{k} proposed here instead of q^{k} used in Geist et al. ReLOAD converges, while μ-MDPI oscillates and fails to converge in the last iterate, even though the average of the policies produced by μ-MDPI, denoted μ-MDPI-Avg does converge. In other words, only ReLOAD achieves LIC, while μ-MDPI only achieves AIC.

In other implementations, particularly ones having a larger number of possible actions and/or a larger number of possible states of the environment, the policy model and mixed reward function may be implemented by respective adaptive models (e.g. neural networks) defined by parameters which are iteratively trained (i.e. modified at each iteration). These adaptive models provide a function approximation to replace the complete freedom to independently choose all values of n^{k+1} (a, s) in the tabular case.

Specifically, the policy model 122 may be defined by a “policy” neural network having by a number (e.g. denoted N_{π}) of tunable parameters. The values of the parameters set in the k-th iteration define π^{k}. In some cases, the policy model 122 may be a q-network, used to generate the policy output used by the action selection unit 126.

Similarly, the mixed reward function (and/or another of the reward functions and/or the cost functions) may be defined by a “value” neural network having a number (e.g. denoted N_{μ}) of tunable parameters. The values of the parameters of the value neural network set in the k-th iteration define the mixed reward function q_{μ}^{k}.

The updating of the policy (e.g. the generation of π^{k+1}) to implement Eqn. (5) may be performed with a wide variety of reinforcement learning algorithms which have been proposed in the field of reinforcement learning under the general heading of Q-learning, as described at https://en.wikipedia.org/wiki/Q-learning for example. Some of these use loss functions proposed with specific objectives in mind in addition to performing the task(s), such as to promote exploration of the environment, e.g. in case this makes possible a superior performance of the task. From another point of view, the present techniques may be considered as a particular way of implementing a policy update iteration of those known techniques, in which the mixed reward function q_{μ}^{k} based on μ^{k} replaces a reward function used in those techniques, and the policy update iteration is supplemented by an update to μ^{k}.

In one implementation the present technique may be used with a reward function of the algorithm known as Maximum a Priory Policy Optimisation, A. Abdolmaleki et al, 2018, https://arxiv.org/abs/1806.06920. The present technique can also be used for the generalization of this technique for multiple objectives described in “A distributional view on multi-objective policy optimization” by A. Abdolmaki et al, 2020, https://arxiv.org/abs/2005.07513.

Another known policy model training method for which it can be used is to implement “IMPALA: Scalable Distributed Deep-RL with Importance Weighted Actor-Learner Architectures”, L. Espehot et al, 2018, https://arxiv.org/abs/1802.01561, which aims to allow a single reinforcement learning agent to solve a large collection of tasks.

Yet another known policy model training method for which the present technique can be used is the MuZero algorithm introduced in “Mastering Atari, Go, Chess and Shogi by Planning with a Learned Model”, Schrittwieser et al., 2019, https://arxiv.org/abs/1911.08265, which combines a tree-based search with a learned model, to solve a range tasks without knowledge of the underlying dynamics of the environment.

As each iteration employs the mixed reward function and policy model generated in the previous iteration, the values of one or both of the policy neural network and value neural network generated the k−1 iteration may be retained after the successive corresponding policy neural network and/or value neural network are generated. They may be used, in combination respectively with the successive generated policy neural network and/or value neural network, for the next update respectively to the multiplier values and/or policy model.

The form of the neural networks may be selected in a way appropriate to the observations and actions, as is conventionally done for the neural networks used as policy models for reinforcement learning. For example, in situations in which the observations are images, the policy neural network and/or value neural network(s) may be chosen to include convolutional layer(s) (e.g. as the input layer(s) of the neural networks). Optionally, some of these layers may be pre-trained (e.g. to provide feature recognition), and their parameters may not be varied during the training of the policy model.

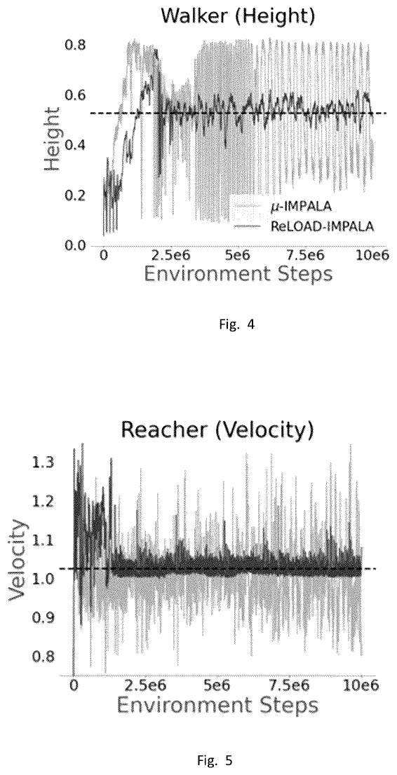

Experimental results are now presented for two tasks with constraints which are present in the DeepMind Control Suite, specifically the constrained tasks (1) “Walker, walk”, which is a task of teaching a mechanical agent (robot) to walk, with a constraint on the height of the agent; and (2) “Reacher, Easy” which a task of a robot penetrating a target region, with a constraint on the velocity of the agent. The results are shown in FIGS. 4 and 5. Here “μ-Implala” is a variant of the Impala method (described in L. Espehot et al, 2018, mentioned above) which performs an iterative process which, in each iteration, (i) performs an inner loop by the Impala method to find a policy which minimizes r_{μ} instead of −r₀ for a given set of values μ, and (ii) a step of updating μ to maximize the Lagrangian of Eqn. (3) without taking into account the μ derived in the last-but-one iteration. In FIGS. 4 and 5, the results for μ-Implala” are shown with a light-colored line. An example of the present disclosure, ReLOAD-Impala is shown by a darker line.

In each case, ReLOAD-IMPALA significantly dampens oscillations compared to μ-Implala. For Walker, ReLOAD produces an agent which moves forward with a modified, kneeling walk, while for μ-Implala the agent typically either ends up lying down, or walking normally and ignoring the constraint. Similarly, for Reacher, the agent controlled by a policy model trained by ReLOAD moves quickly while keeping the tip of its arm in the target region, while the μ-Implala agent either stops moving within the target region, or maximizes its velocity while swinging in a circle and ignoring the task.

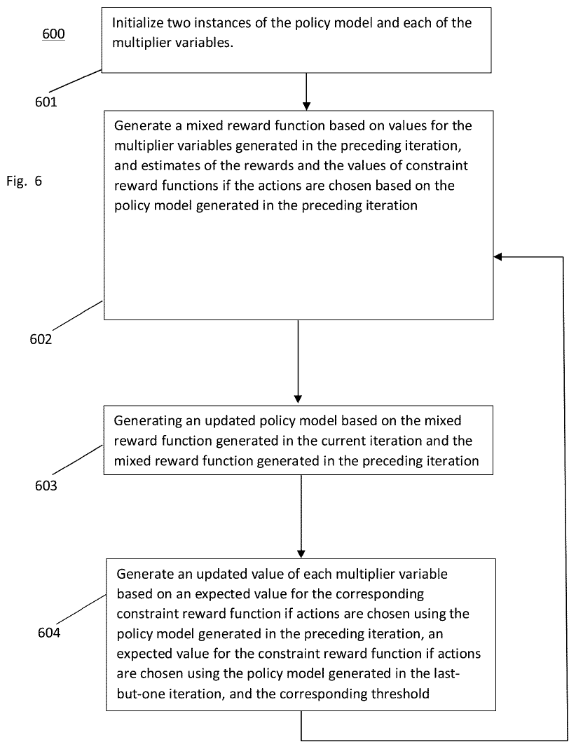

Turning to FIG. 6, an example method 600 is shown. In a first step 601, an initialization is performed. This includes setting initial parameters for parameters which are iterated in later steps of the method, such as values for π¹, μ¹, π², μ².

The steps 602-604 are then performed repeatedly as an iteration of the training method. Steps 602-603 correspond to Eqn. (5) and step 604 corresponds to Eqn. (6).

In step 602, a mixed reward function is generated based on values for the multiplier variables generated in the preceding iteration, and estimates of the rewards and the values of constraint reward functions if the actions are chosen based on the policy model generated in the preceding iteration. In the case of the first iteration, π² is used as the policy model generated in the preceding iteration, and μ² is used as the multiplier variables generated in the preceding iteration.

In step 603, an updated policy model is generated based on expected values under the updated policy model of the mixed reward function generated in the current iteration and the mixed reward function generated in the preceding iteration. In the case of the first iteration, a mixed reward function generated based on π¹ and μ¹ is used as the mixed reward function generated in the preceding iteration.

In step 604, an updated value of each multiplier variable is generated based on an expected value for the cost function if actions are chosen using the policy model generated in the preceding iteration, an expected value for the corresponding cost function if actions are chosen using the policy model generated in the last-but-one iteration, and the corresponding threshold. In the case of the first iteration, π² is used as the policy model generated in the preceding iteration and π¹ is used as the policy model generated in the last-but-one iteration. In the case of the second iteration, π² is used as the policy model generated in the last-but-one iteration.

After step 604, if the value k is no greater than K, then k is increased by 1 and the method returns to step 602.

The subject matter described in this specification can be implemented in particular embodiments so as to realize one or more of the following advantages.

Firstly, a policy model can be trained which generates actions which satisfy constraints, not just in an average sense over multiple policy models, but in the sense that the policy model generated after any sufficient number of iterations, generates actions which both obey the constraint(s) and perform the desired task. For example, since at least one constraint may represent a safety requirement, actions generated by an action selection system based on the present policy model may be safer than actions selected with policy models trained by known algorithms. Furthermore, since the constraint may be one constraint may represent a limitation on resources consumed when the actions selected by the action selection system are performed, actions generated by an action selection system based on the present policy model may consume less resources than actions selected with known policy models. Furthermore, policy models trained by the present algorithm are more likely to generate actions which perform the task better, since they are less likely to policy models in which too much emphasis has been placed on meeting the constraints.

Secondly, the computational resources (e.g. number of computational operations) required to train the policy model may be less than in a conventional method of training a policy model subject to constraints, since convergence is more rapid and cyclic training phenomena can be reduced, or in some cases even eliminated.

There is now a discussion of some technical applications in which the present reinforcement learning techniques can be employed. In some implementations, the environment is a real-world environment, and the constraints are constraints on costs incurred by the agent when acting in the real-world to perform the task.

The agent may be a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In such applications the rewards and/or costs may include, or be defined based upon the following:

One or more rewards or costs for approaching or achieving one or more target locations, one or more target poses, or one or more other target configurations, e.g. to reward a robot arm for reaching a position or pose and/or for constraining movement of a robot arm. A reward or cost may also be associated with collision of a part of a mechanical agent with an entity such as an object or wall or barrier. One or more rewards or costs dependent upon any of the previously mentioned observations e.g. robot or vehicle positions or poses. For example in the case of a robot a reward or cost may depend on a joint orientation (angle) or speed/velocity e.g. to limit motion speed, an end-effector position, a center-of-mass position, or the positions and/or orientations of groups of body parts. A reward or cost may also or instead be associated with force applied by an actuator or end-effector, e.g. dependent upon a threshold or maximum applied force when interacting with an object; or with a torque applied by a part of a mechanical agent. For example, a robot may be trained to run while avoiding placing too much torque on its joints.

In another example a reward or cost may also or instead be dependent upon energy or power usage, excessive motion speed, one or more positions of one or more robot body parts e.g. for constraining movement, and so forth. A corresponding constraint may be defined for each of these costs. Multiple constraints may be used to define an operational envelope for the agent.

Where the agent or robot comprises an autonomous or semi-autonomous moving vehicle similar rewards and costs may apply. Also or instead such an agent or robot may have one or more rewards or costs relating to physical movement of the vehicle, e.g. dependent upon energy or power use whilst moving e.g. to define a maximum or average energy use, speed of movement, a route taken when moving e.g. to penalize a longer route over a shorter route between two points, as measured by distance or time. Such an agent or robot may be used to perform a task such as warehouse, logistics, or factory automation, e.g. collecting, placing, or moving stored goods or goods or parts of goods during their manufacture; or the task performed may comprise a package delivery control task. Thus one or more of the rewards or costs may relate these tasks, the actions may include actions relating to steering or other direction control actions, and the observations may include observations of the positions or motions of other agents e.g. other vehicles or robots.

In some implementations the environment is a simulation of the above-described real-world environment. The same observations, actions, rewards and costs may be applied to a simulation of the agent in the simulation of the real-world environment. The agent may be implemented as one or more computers interacting with the simulated environment. For example the simulated environment may be a simulation of a robot or vehicle and the reinforcement learning system may be trained on the simulation and then, once trained, used in the real-world. That is control signals generated by the system/method may be used to control the real-world agent to perform a task in the real-world environment in response to observations from the real-world environment. Optionally the system/method may continue training in the real-world environment.

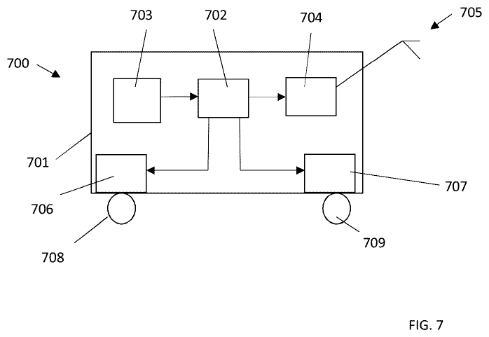

As an example, FIG. 7 shows a robot 700 having a housing 701. The robot includes, e.g. within the housing 701 (or, in a variation, outside the robot 700 but connected to it over a communications network), a control system 702 which comprises an action selection system defined by a plurality of model parameters for each of one or more tasks which the robot is configured to perform. The control system 702 may comprise the action selection subsystem 102 of FIG. 1. The control system 702 has access for a corresponding database of model parameters for each given task, which may have been obtained for that task by the method 600 of FIG. 6. The robot 700 further includes one or more sensors 703 which may comprise one or more (still or video) cameras. The sensors 3 capture observations (e.g. images) of an environment of the robot 700, such as room in which the robot 700 is located (e.g. a room of an apartment). The robot may also comprise a user interface (not shown) such as microphone for receiving user commands to define a task which the robot is to perform. Based on the task, the control system 702 may read the corresponding model parameters and configure the action selection subsystem 102 based on those model parameters. Note that, in a variation, the input from the user interface may be considered as part of the observations. There is only a single task in this case, and processing the user input is one aspect of that task.

Based on the observations captured by the sensors 703, control system 702 generates control data for an actuator 704 which controls at least one manipulation tool 705 of the robot, and control data for controlling drive system(s) 706, 707 which e.g. turn wheels 708, 709 of the robot or move feet (not shown) of the robot, causing the robot 700 to move through the environment according to the control data. Thus, the control system 702 can control the manipulation tool(s) 705 and the movement of the robot 700 within the environment.

In some implementations the environment is a real-world manufacturing plant for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment. The reward(s) and/or cost(s), to be maximized and constrained, may include one or more of: a measure of efficiency, e.g. resource usage; a measure of the environmental impact of operations in the environment, e.g. waste output; electrical or other power or energy consumption; heating/cooling requirements; resource use in the facility e.g. water use; a temperature of the facility or of an item of equipment in the facility; a count of characteristics of items within the facility.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return and/or constraints/costs may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return and/or constraints/costs may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

In another implementation, the environment may be a sequence of video frames, and the task may comprise designing a codec for compressing the video frames into a compressed signal. In this case, the constraints may relate to quality measures of a sequence of video frames which can be reconstructed from the compressed signal. A quality measure may be obtained by comparing the original sequence of video frames to the reconstructed video frames, and may for example be in the form of a PSNR (peak signal-to-noise ratio). Alternatively or additionally, constraint(s) may be framed based on the compressed signal, such as the bitrate requirement for transmitting the compressed signal within a certain time over a channel having defined properties.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some applications the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The reward(s) and/or cost(s) may then be dependent on one or more routing metrics such as interconnect length, resistance, capacitance, impedance, loss, speed or propagation delay; and/or physical line parameters such as width, thickness or geometry, and design rules. The cost(s) may also include one or more cost(s) relating to a global property of the routed circuitry e.g. component density, operating speed, power consumption, material usage, a cooling requirement, level of electromagnetic emissions, and so forth. One or more constraints may be defined in relation to the one or more costs. The observations may be e.g. observations of component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent is a software agent and the environment is a real-world computing environment. In one example the agent manages distribution of tasks across computing resources e.g. on a mobile device and/or in a data center. In these applications, the observations may include observations of computing resources such as compute and/or memory capacity, or Internet-accessible resources; and the actions may include assigning tasks to particular computing resources. The reward(s) and costs(s) may be configured to maximize or minimize or constrain one or more of: utilization of computing resources, electrical power, bandwidth, and computation speed.

In another example the software agent manages the processing, e.g. by one or more real-world servers, of a queue of continuously arriving jobs. The observations may comprise observations of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the reward(s) and/or cost(s) may be configured to minimize or constrain an overall queueing or processing time or the queueing or processing time for one or more individual jobs, or in general to optimize any metric based on the observations.

As another example the environment may comprise a real-world computer system or network, the observations may comprise any observations characterizing operation of the computer system or network, the actions performed by the software agent may comprise actions to control the operation e.g. to limit or correct abnormal or undesired operation e.g. because of the presence of a virus or other security breach, and the reward(s) and/or cost(s)/constraint(s) may comprise any metric(s) that characterizing desired operation of the computer system or network.

In some applications, the environment is a real-world computing environment and the software agent manages distribution of tasks/jobs across computing resources e.g. on a mobile device and/or in a data center. In these implementations, the observations may comprise observations that relate to the operation of the computing resources in processing the tasks/jobs, the actions may include assigning tasks/jobs to particular computing resources, and the reward(s) and/or cost(s)/constraints may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In some applications the environment is a data packet communications network environment, and the agent is part of a router to route packets of data over the communications network. The actions may comprise data packet routing actions and the observations may comprise e.g. observations of a routing table which includes routing metrics such as a metric of routing path length, bandwidth, load, hop count, path cost, delay, maximum transmission unit (MTU), and reliability. The reward(s) and cost(s)/constraint(s) may be defined in relation to one or more of the routing metrics i.e. configured to maximize one or more of the routing metrics.

In some other applications the environment is an Internet or mobile communications environment and the agent is a software agent which manages a personalized recommendation for a user. The observations may comprise previous actions taken by the user, e.g. features characterizing these; the actions may include actions recommending items such as content items to a user. The reward(s) and/or cost(s)/constraint(s) may be configured to maximize or constrain one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metrics of performance of the design of the entity. For example rewards or returns may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. During an on-policy training phase and/or another phase in which the history database is being generated, the experience tuples may record the action which the user actually performed based on the instruction, rather than the one which the reinforcement learning system instructed the user to perform. The reward value of each experience tuple may be generated, for example, by comparing the action the user took with a corpus of data showing a human expert performing the task, e.g. using techniques known from imitation learning. The constraints/costs may for example, limit the complexity of the action the agent/user is asked to perform, or the resources which the agent/user uses to perform the task. Note that if the user performs actions incorrectly (i.e. performs a different action from the one the reinforcement learning system instructs the user to perform) this adds one more source of noise to sources of noise which may already exist in the environment. During the training process the reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

As an illustrative example a user may be interacting with a digital assistant and ask for help performing an overall task consisting of multiple steps, e.g. cooking a pasta dish. While the user performs the task, the digital assistant receives audio and/or video inputs representative of the user's progress on the task, e.g. images or video or sound clips of the user cooking. The digital assistant uses a system as described above, in particular by providing it with the captured audio and/or video and a question that asks whether the user has completed a particular step, e.g. ‘Has the user finished chopping the peppers?’, to determine whether the user has successfully completed the step. If the answer confirms that the use has successfully completed the step then the digital assistant progresses to telling the user to perform the next step or, if at the end of the task, or if the overall task is a single-step task, then the digital assistant may indicate this to the user. The digital assistant may then stop receiving or processing audio and/or video inputs to ensure privacy and/or reduce power use.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as LaMDA, Sparrow, or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In the implementations above, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). Constraints/costs may limit the complexity of the problems the user is asked to perform, or a level the user must attain for each reinforcement of a skill before the reinforcement learning system begins to improve another aspect of the skill, or the proportions of the problems set by the reinforcement learning system which relate to corresponding portions of the skill. In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. The costs/constraints may limit the overall complexity of the task, and/or the resources required by the computer system to perform the task. In this way, a personalized system may be provided for the user to control the computer system, again tailored to the aptitudes and current knowledge of the user.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of training a policy model of an action selection system to select actions of an agent interacting with an environment to perform one or more tasks, each task having at least one respective reward associated with performance of the task, the agent being controlled by a process comprising, at a plurality of time steps:
obtaining a current observation characterizing a current state of the environment;
processing the current observation using the policy model to select an action to be performed by the agent at the time step; and
obtaining a subsequent observation characterizing a subsequent state of the environment at a next time step after the agent performs the selected action;
each constraint limiting, to a corresponding threshold, the value of a corresponding constraint reward function dependent on at least one of the subsequent observation and the selected action, if the actions of the agent are chosen according to the policy model, each constraint being associated with a corresponding multiplier variable;
the method comprising a plurality of iterations, each iteration comprising:
generating a mixed reward function based on values for the multiplier variables generated in the preceding iteration, and estimates of the rewards and the values of constraint reward functions if the actions are chosen based on the policy model generated in the preceding iteration;
generating an updated policy model using the mixed reward function generated in the current iteration and the mixed reward function generated in the preceding iteration; and
generating an updated value of each multiplier variable based on an expected value for the corresponding constraint reward function if actions are chosen using the policy model generated in the preceding iteration, an expected value for the corresponding constraint reward function if actions are chosen using the policy model generated in the last-but-one iteration, and the corresponding threshold.

2. The method of claim 1, in which the mixed reward function is based on (i) a return function indicative of expected future rewards if the actions are chosen using policy model generated in the preceding iteration, (ii) for each constraint, a corresponding constraint cost function indicative of expected values of the corresponding constraint reward function if the actions are chosen using the policy model generated in the preceding iteration, and (iii) for each constraint, a value of the corresponding multiplier variable generated in the preceding iteration.

3. The method of claim 2, in which the mixed reward function is indicative of a sum over the constraints, weighted by the respective values of the multiplier variables generated in the preceding iteration, of the corresponding constraint cost function indicative of expected values of the corresponding constraint reward function if the actions are chosen using the policy model generated in the preceding iteration, minus the return function indicative of expected future rewards if the actions are chosen using policy model generated in the preceding iteration.

4. The method of claim 1, in which, in each iteration, the updated policy model is generated as an updated policy model which minimizes an expression comprising the expected value under the updated policy model for the mixed reward function for the preceding iteration, minus a weight factor times the expected value under the updated policy model of the mixed reward function obtained in the current iteration.

5. The method of claim 4, in which the weight factor is 2.

6. The method of claim 1, in which, in each iteration, the policy model is generated as a policy model which minimizes an expression comprising a policy stabilization function of the policy model generated in the current observation, the policy stabilization function being indicative of a divergence between the policy model generated in the current iteration and the policy model generated in the preceding iteration.

7. The method of claim 6 in which the policy stabilization function is a Kullback-Leibler divergence between the policy model generated in the current iteration and the policy model generated in the preceding iteration.

8. The method of claim 6, in which the policy stabilization function is weighted by a first step size parameter which is different for different iterations, the weighting being higher for later iterations.

9. The method of claim 1, in which, in each iteration, the updated value of the multiplier variables are generated as values for the multiplier variables which maximize an expression having a term which is a sum over the constraints of the corresponding multiplier variable multiplied by:
a first constraint weight factor times the expected value for the corresponding constraint reward function if actions are chosen using the policy model generated in the preceding iteration,
minus a second constraint weight factor times the expected value for the corresponding constraint reward function if actions are chosen using the policy model generated in the last-but-one iteration,
minus the corresponding threshold.

10. The method of claim 9, in which the first constraint weight factor is 2 and the second constraint weight factor is 1.

11. The method of claim 1 in which, in each iteration, the updated value of the multiplier variables are generated as values for the multiplier variables which maximize an expression having a term which is a multiplier stabilization function indicative of a difference between the multiplier variables and the values of the multiplier variables generated in the preceding iteration.

12. The method of claim 11, in which the multiplier stabilization function is weighted using a second step size parameter which is different for different iterations, the weighting being higher for later iterations.

13. The method of claim 1 in which the policy model and mixed reward function are generated as respective tables having a value for each combination of a possible state and possible action.

14. The method of claim 13 in which the value of the policy model for each combination is generated in the current iteration as a value proportional to the corresponding value of the policy model generated in the preceding iteration, multiplied by the exponent of a term which is proportional to a weight factor times the mixed reward function obtained in the current iteration, minus the mixed reward function generated in the preceding iteration.

15. The method of claim 1, wherein the value of the each multiplier variable is generated in the current iteration as the higher of (i) zero and (ii) the sum of the value of the multiplier variable in the preceding iteration plus a term proportional to a first constraint factor times the expected value for the corresponding constraint reward function if actions are chosen using the policy model generated in the preceding iteration, minus a second constraint factor times the expected value for the corresponding constraint reward function if actions are chosen using the policy model generated in the last-but-one iteration, minus the corresponding threshold.

16. The method of claim 1 in which the policy model and mixed reward function are based on corresponding neural networks, and in each iteration the generating of the mixed reward function and the generating of the updated policy model comprise generating corresponding sets of numerical parameters for the corresponding neural network models.

17. The method of claim 16 in which the parameters of the neural network generated to generate the mixed reward function in each iteration are employed in the generation of the policy model in the next iteration.

18. One or more computer storage media storing instructions that when executed by one or more computers cause the one or more computers to train iteratively an action selection neural network system to select, based on observations characterizing a current state of an environment, actions to be performed by an agent interacting with the environment to perform one or more tasks subject to one or more constraints,
each task having at least one respective reward associated with performance of the task, and each constraint limiting, to a corresponding threshold, the value of a corresponding constraint reward function dependent on at least one of the observation and the selected action, each constraint being associated with a corresponding multiplier variable;
each iteration comprising:
generating a mixed reward function based on values for the multiplier variables generated in the preceding iteration, and estimates of the rewards and the values of constraint reward functions if the actions are chosen based on the policy model generated in the preceding iteration;
generating an updated policy model using the mixed reward function generated in the current iteration and the mixed reward function generated in the preceding iteration; and
generating an updated value of each multiplier variable based on an expected value for the constraint reward function if actions are chosen using the policy model generated in the preceding iteration, an expected value for the corresponding constraint reward function if actions are chosen using the policy model generated in the last-but-one iteration, and the corresponding threshold.

19. A system comprising:
one or more computers; and
one or more storage devices communicatively coupled to the one or more computers, wherein the one or more storage devices store instructions that, when executed by the one or more computers, cause the one or more computers to train iteratively an action selection neural network system to select, based on an observation characterizing a current state of an environment, an action to be performed by an agent interacting with the environment to perform one or more tasks subject to one or more constraints,
each task having at least one respective reward associated with performance of the task, and each constraint limiting, to a corresponding threshold, the value of a corresponding constraint reward function dependent on at least one of the observation and the selected action, each constraint being associated with a corresponding multiplier variable;
each iteration comprising:
generating a mixed reward function based on values for the multiplier variables generated in the preceding iteration, and estimates of the rewards and the values of constraint reward functions if the actions are chosen based on the policy model generated in the preceding iteration;
generating an updated policy model using the mixed reward function generated in the current iteration and the mixed reward function generated in the preceding iteration; and
generating an updated value of each multiplier variable based on an expected value for the constraint reward function if actions are chosen using the policy model generated in the preceding iteration, an expected value for the corresponding constraint reward function if actions are chosen using the policy model generated in the last-but-one iteration, and the corresponding threshold.

20. The system of claim 19, in which the mixed reward function is based on (i) a return function indicative of expected future rewards if the actions are chosen using policy model generated in the preceding iteration, (ii) for each constraint, a corresponding constraint cost function indicative of expected values of the corresponding constraint reward function if the actions are chosen using the policy model generated in the preceding iteration, and (iii) for each constraint, a value of the corresponding multiplier variable generated in the preceding iteration.
